(19) United States
(12) Patent Application Publication
(10) Pub. No.: US 2016/0148160 A1
(43) Pub. Date: May 26, 2016

(54) SYSTEM AND METHOD OF FACILITATING JOB RECRUITMENT

(71) Applicant: Henry Kofi Amankwah, London (GB)

(72) Inventor: Henry Kofi Amankwah, London (GB)

(21) Appl. No.: 14/552,315

(22) Filed: Nov. 24, 2014

(51) Int. Cl. G06Q 10/10

(52) U.S. Cl. CPC G06Q 10/1053

(57) ABSTRACT

An improved system for facilitating job recruitment is disclosed. The embodiments comprise a job recruitment website that matches employers and job applicants. The website presents a job applicant with a short list of relevant job opportunities and presents an employer with a short list of relevant candidates who satisfy the criteria of the job opening. This results in a system that is suitable for use on a mobile phone.

### TECHNICAL FIELD

An improved system for facilitating job recruitment is disclosed.

### BACKGROUND OF THE INVENTION

The prior art includes employment and recruitment websites to assist individuals in finding job opportunities and to assist employers in finding employees. However, prior art websites typically operate as notice boards where employers will post job opportunities and solicit applications, and individuals will sift through the job descriptions and submit applications in large volumes.

From the individual's perspective, finding appropriate job opportunities on prior art websites can be a frustrating process. After reading a brief title of a job opportunity, the individual typically must click a link to view a full job description and must do this every time he or she wants to view a job opening. This is an arduous process, and finding appropriate job opportunities can take days or weeks. Job descriptions often are poorly written, and the individual then needs to send an inquiry to the employer and must wait days to hear back. The process can be disheartening as most employers simply elect not to respond, and there is no way for the individual to know if their application is being considered and how long it will take to receive a reply. Prior art websites also are not suitable for individuals with slow Internet connections or whose only Internet access is via a mobile phone.

From the employer's perspective, finding candidates for job openings using prior art websites can be a bad experience as well. Employers receive too many applicants that do not fit the employer's criteria for a job opening. Employers often must designate a full time employee to spend most of his or her time sifting through online job applications for candidates who do not fit the criteria for the job opening. Many employers hire expensive recruitment consultants to perform this work for them. However, not all employers can afford to use a full time employee or a consultant, particularly smaller employers that make up a significant part of the job market.

What is needed is a job recruitment system that matches individuals with employers and provides a targeted list of relevant individuals to the employer and a targeted list of relevant employers to the individual. What is further needed is a job recruitment system that is suitable for mobile phones.

### SUMMARY OF THE INVENTION

The embodiments disclosed herein comprise a job recruitment website that matches employers and job applicants. The website presents a job applicant with a short list of relevant job opportunities and presents an employer with a short list of relevant candidates who satisfy the criteria of the job opening. This results in a system that is suitable for use on a mobile phone.

### BRIEF DESCRIPTION OF THE DRAWINGS

FIG. 1 depicts an exemplary recruitment system.

FIG. 2 depicts additional aspects of an exemplary recruitment system.

FIG. 3 depicts an aggregation and analysis engine within the recruitment system.

FIG. 4 depicts a method of providing job applicant candidates to an employer.

FIG. 5 depicts a method of providing candidate job openings to a job applicant.

FIG. 6 depicts a method of providing job applicant candidates to an employer.

FIG. 7 depicts a method of providing candidate job openings to a job applicant.

### DETAILED DESCRIPTION OF THE PREFERRED EMBODIMENTS

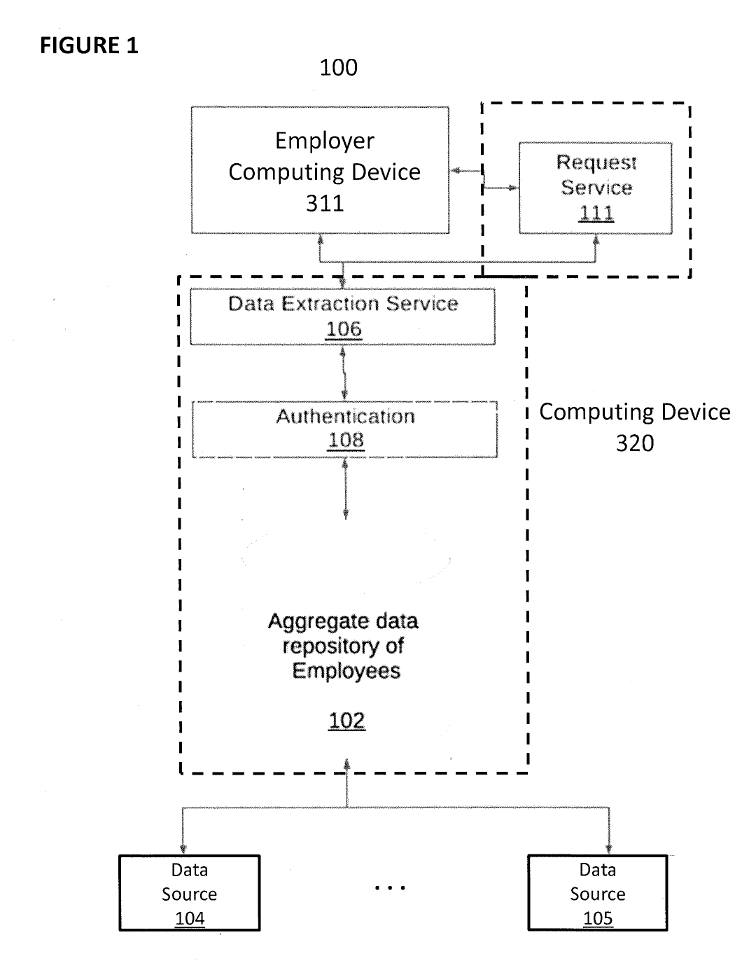

FIG. 1 depicts aspects of recruitment system 100. Recruitment system 100 comprises a plurality of data sources comprising data source 104 for job applicant #1 and data source 105 for job applicant #n (where n is an integer). It is to be understood that an unlimited number of data sources, each corresponding to a job applicant, can be used and that data source 104 and data source 105 are representative. Data source 104 and data source 105 each can comprise data structures or data sets that are generated from data input by the respective job applicants using a computing device such as job applicant computing device 312.

Data sources 104 and 105 and other data sources provide data to the aggregate data repository of job applicants 102 through a web interface, API, or other mechanism. Repository 102 comprises non-volatile storage (such as one or more hard disk drives or one or more solid state drives) containing a database that groups together data from data sources 104 and 105 and stores the data in a plurality of tables to improve efficiency when querying. Alternatively, repository 102 comprises an XML document, JSON output, or any other aggregated format in which data is grouped together in fields.

In the embodiment of the invention, data sources 104 through 105 will provide repository 102 with specific information about job applicants. The information can include, for example: current and previous employers, job titles, professional awards, professional accomplishments, educational history, professional certification or registration, names of cities in which the job applicant would like to work, further geographic distinctions within cites (e.g., the Financial District of San Francisco), languages spoken, passports held, citizenship, visa status, criteria of the types of jobs the job applicant is looking for, industries of interest, industries that are not of interest, companies of interest, and companies that are not of interest.

An employer can request information regarding relevant job applicants for a job opening. The request can be made directly by an employer through employer computing device 311, or through a request service 111 (e.g., through an API).

For example, the employer may log in to its account operated by recruitment system 100 using employer computing device 311, such as through a web interface, to retrieve results, and this request may be directly linked to a data extraction service 106. Alternatively, for example, the employer may have its own internal system and request results via the API-request service 111, and, directly or indirectly, via a data extraction service 106. In any case, some or all of the job applicant results will be provided by data extraction service 106. Other data extraction services in addition to data extraction service 106 can be used, and data extraction service 106 is exemplary. Those skilled in the art will appreciate that these results may be presented in numerous ways without departing from the spirit and/or scope of this invention.

Data extraction service 106 is configured to generate matches and other relevant results stored in the aggregate data repository 102. The data extraction service 106 may be thought of as output services for the aggregate data repository 102. The data sources 104 through 105 may be thought of as input services for the aggregate data

Access to the aggregate data repository 102 is restricted using an authentication service 108, which is configured to ensure that only authorized data extraction services are given access to the aggregate data repository 102. For example, authentication service 108 can require data extraction service 106 to present a user-name/password, an encrypted digital signature, or any other type of authorization credential recognized to be valid by the authentication service 108.

Data extraction service 106 and authentication service 108 optionally can be provided through lines of code executed by the processor of a computing device and can be accessed through a web site offered by a web server such as an Apache server. Computing device 320 (such as a server) optionally can be used to operate request service 111, data extraction service 106, authentication service 108, and aggregate data repository of employees 102.

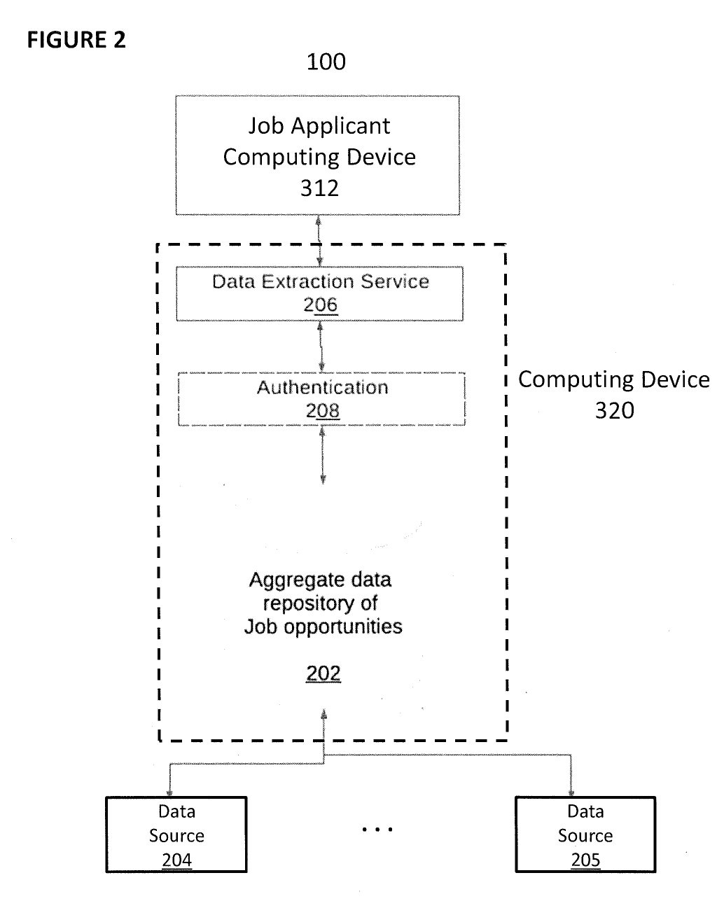

FIG. 2 depicts additional aspects of recruitment system 100. Recruitment system 100 comprises a plurality of data sources comprising data source 204 for job opening #1 and data source 205 for job opening #n (where n is an integer). It is to be understood that an unlimited number of data sources, each corresponding to a job opening, can be used and that data source 204 and data source 205 are representative. Data source 204 and data source 205 each can comprise data structures or data sets that are generated from data input by the respective employers using a computing device, such as employer computing device 311.

Data source 204 and data source 205 provide data to the aggregate data repository of job opportunities 202 through a web interface, API, or other mechanism. Repository 202 can reside within the same system as repository 102, or it can reside in a different system. Repository 202 comprises non-volatile storage (such as one or more hard disk drives or one or more solid state drives) containing a database that groups together data from data sources 204 and 205 and stores the data in a plurality of tables to improve efficiency when querying. Alternatively, repository 202 comprises an XML document, JSON output, or any other aggregated format in which data is grouped together in fields.

In the embodiment of the invention, data sources 204 through 205 provide specific information regarding the job opening. The information can include, for example: company name, company location, job role, salary, daily or weekly hours, minimum qualifications, languages required etc.

Requests for access to job opportunities may be made directly by a job applicant. For example, job applicant may log into his or her account operated by system 100 to retrieve results, such as through a web interface, and this request will be directly linked to a data extraction service 206. All of the job opportunity results will be provided by data extraction service 206. Those skilled in the art will appreciate that these results may be presented in numerous ways without departing from the spirit and/or scope of this invention. Other data extraction services in addition to data extraction service 206 can be used, and data extraction service 206 is exemplary.

Data extraction service 206 is configured to generate matches and other relevant results stored in the Aggregate data repository of Job opportunities 202. The data sources 204 through 205 may be thought of as input services for the Aggregate data repository of Job opportunities 202. The data extraction service 206 may be thought of as output services for the aggregate data repository 202.

Access to the Aggregate data repository of Job opportunities 202 is restricted using authentication service 208. Authentication service 208 is configured to ensure that only authorized data extraction services are given access to the Aggregate data repository of Job opportunities 202. For example, authentication service 208 will require data extraction service 206 to present a user-name/password, an encrypted digital signature, or any other type of authorization credential recognized to be valid by authentication service 208.

Data extraction service 206 and authentication service 208 optionally can be provided through lines of code executed by the processor of a computing device and can be accessed through a web site offered by a web server such as an Apache server. Computing device 320 (such as a server) optionally can be used to operate data extraction service 206, authentication service 208, and aggregate data repository of job opportunities 202.

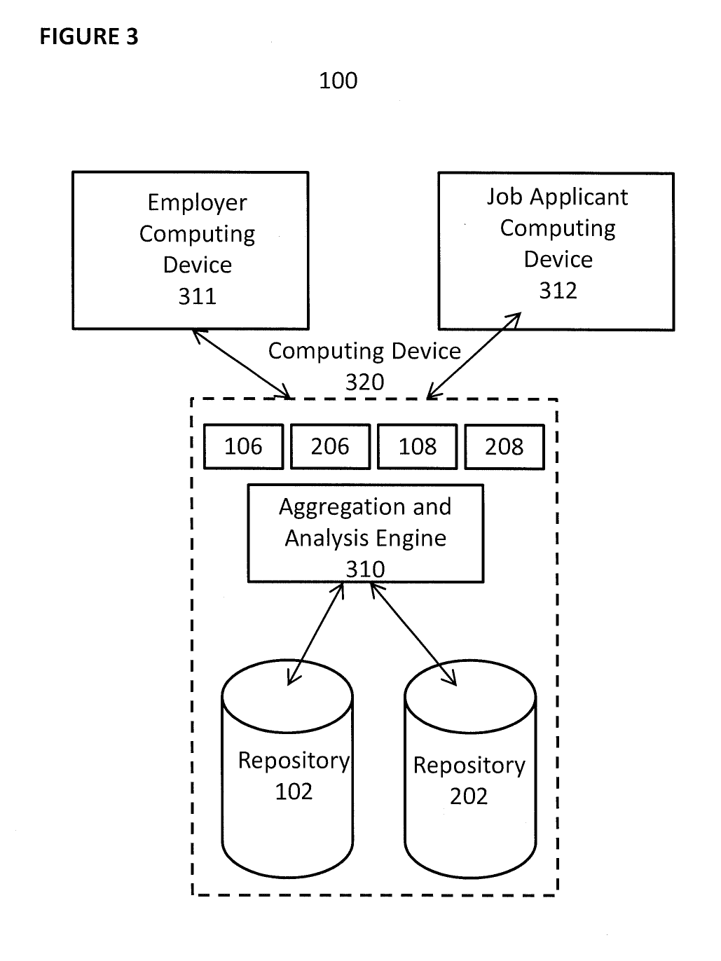

FIG. 3 depicts another aspect of recruitment system 100. Recruitment system further comprises aggregation and analysis engine 310, which is coupled to repository 102 and repository 202 and can be accessed by employer computing device 311 and job applicant computing device 311. Aggregation and analysis engine 310 can analyze the data included in repository 102 and repository 202 and provide data and/or reports to employer computing device 311 and job applicant computing device 312 as discussed in greater detail below. Aggregation and analysis engine 310 can be implemented as lines of software code executed by computing device 320, such as a server.

Aggregation and analysis engine 310 can inform job applicant that he or she is applying for a job which falls into a labor shortage area, and in which countries those shortages occur. The labor shortage flag will encourage candidates in foreign countries to apply for jobs in labor shortage areas, as their chances of obtaining a working visa would be higher. Aggregation and analysis engine 310 also can provide job applicant with data regarding the average salary or range of salary of other people in the same field, which will enable the job applicant to manager his or her expectations appropriately.

The data in these examples is compiled by aggregation and analysis engine 310 using data submitted by employers and job applicants contained in repository 102 and repository 202. This data can be provided through a website, an application, and SMS or MMS message, an email, or another mechanism.

Other features of recruitment system 100 that can be provided to an employer include: setting essential and optimal criteria, having pre-qualified CV's sent to its inbox, automatically receiving highly relevant applicants that fit its criteria exactly, filtering results in seconds (using real-time Ajax), setting up auto record and email to relevant people in the company, deciding if you want to headhunt or go for people unemployed or planning on leaving, watching a pre-recorded video of an applicant, reading reviews about job applicants from former employers, adding reviews from former employers, rating former employees, learning what salary range the job applicant wants, and choosing a method of interview and/or arrange an interview (face to face, Google hangouts, skype, whats app, viber).

Other features of recruitment system 100 that can be provided to a job applicant include: setting criteria, having opportunities sent to inbox automatically, excluding companies he or she does not want to work for, excluding industries or he she does not want to work in, finding jobs in countries where getting a visa will be easy (e.g., Dubai), uploading a portfolio of work (e.g. web designer), uploading a video, changing your status to unemployed, changing status to planning on leaving (Hidden—shows to other companies excluding your current employer), viewing reviews about companies, rate your old or current company, finding out what other people are getting paid in the company you are applying to, inputting the salary minimum you will accept and only get approached by those who are happy to pay that or more, having applications sent to companies automatically, and learning where labor shortages are present.

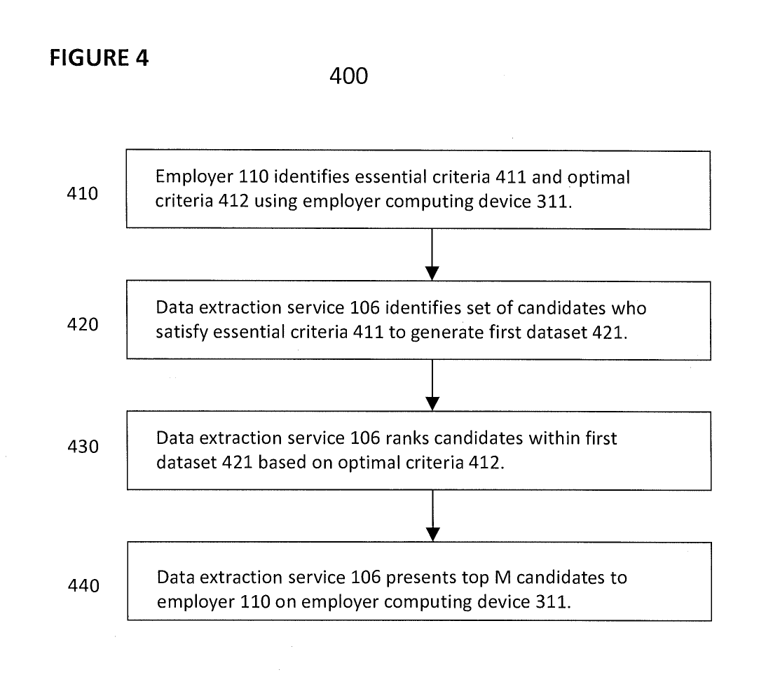

With reference to FIG. 4, a method 400 of using recruitment system 100 to identify top candidates for employer is depicted. In Step 410, employer identifies essential criteria 411 and optimal criteria 412 using employer computing device 311. For example, employer might identify essential criteria 411 such as: Bachelor's Degree in Electrical Engineering; Two years of experience designing RF circuits; Willing to work in Denver, Colo. Employer might identify optimal criteria 412 such as: number of years of experience designing RF circuits.

In Step 420, data extraction service 106 identifies set of candidates who satisfy essential criteria 411 to generate first dataset 421.

In Step 430, data extraction service 106 ranks candidates within first dataset 421 based on optimal criteria 412. For example, if the optimal criteria 412 is number of years of experience designing RF circuits, data extraction service 106 would rank the candidates within the first dataset based on the number of years of experience designing RF circuits.

In Step 440, data extraction service 106 presents top M candidates to employer on employer computing device 311. Here, M is an integer (such as 10) that is predetermined by employer and input into employer computing device 311. Step 440 optionally can be performed using a web site provided by computing device 320 and accessed and displayed by employer computing device 311 (such as a mobile device) or using an API and software application running on employer computing device 311 (such as a mobile device). Step 440 also can be performed by sending an SMS or MMS message or email from computing device 320 to employer computing device 311.

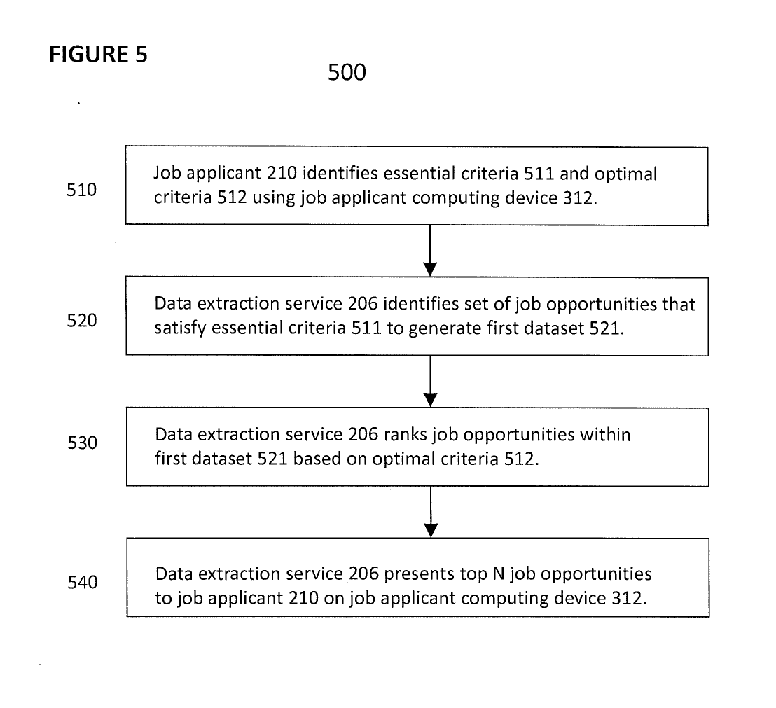

With reference to FIG. 5, a method 500 of using recruitment system 100 to identify top job opportunities for job applicant is depicted. In Step 510, job applicant identifies essential criteria 511 and optimal criteria 512 using job applicant computing device 312. For example, job applicant might identify essential criteria 511 such as: salary of at least $50,000 (US); health insurance provided; job located in London, England. Job applicant might identify optimal criteria 512 as: salary.

In Step 520, data extraction service 206 identifies the set of job opportunities that satisfy the essential criteria 511 to generate a first dataset 521.

In Step 530, data extraction service 206 ranks the job opportunities within the first dataset 521 based on optimal criteria 512. For example, if optimal criteria 512 is salary, data extraction service 206 would rank the job opportunities within the first dataset 521 based on the salary of the opportunity.

In Step 540, data extraction service 206 presents top N candidates to job applicant on job applicant computing device 312. Here, N is an integer (such as 15) that is predetermined by job applicant. Step 540 optionally can be performed using a web site provided by computing device 320 and accessed and displayed by job applicant computing device 312 (such as a mobile device) or using an API and software application running on employer computing device 312 (such as a mobile device). Step 540 also can be performed by sending an SMS or MMS message or email from computing device 320 to job applicant computing device 312.

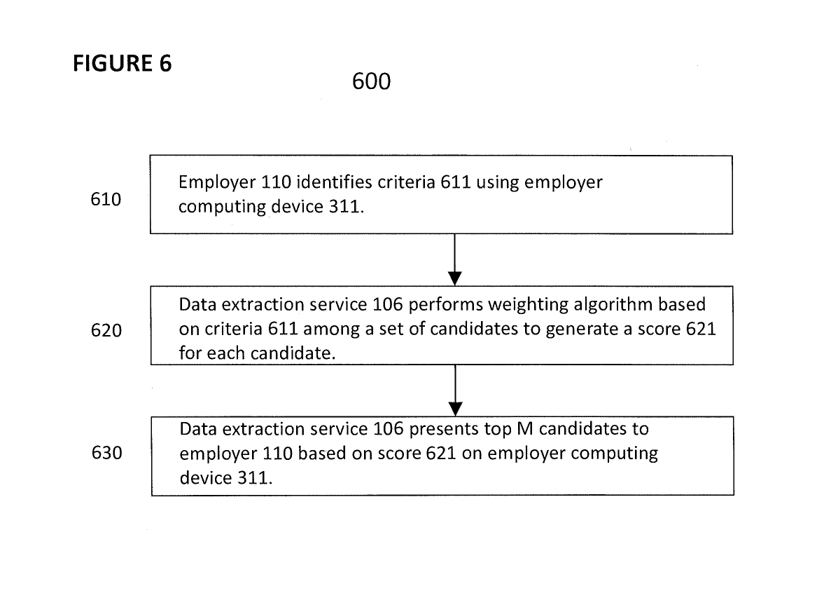

FIG. 6 depicts an alternative to FIG. 4. A method 600 of using recruitment system 100 to identify top candidates for employer is depicted. In Step 610, employer identifies criteria 611 using employer computing device 311. For example, employer might identify criteria 611 such as: Bachelor's Degree in Electrical Engineering; Two years of experience designing RF circuits; Willing to work in Denver, Colo.

In Step 620, data extraction service 106 performs weighting algorithm based on criteria 611 among a set of candidates to generate a score for each candidate. The weighting used can be set by employer, or it can be set by recruitment system 100.

A simple example of Step 620 is the following. Criteria 611 comprises a criteria of five years of industry experience. If a candidate has five or more years of industry experience, data extraction service 106 can assign that candidate a value of 20 for that criteria. If a candidate has four years of industry experience, data extraction service 106 can assign the candidate a value of 16 for that criteria. If the candidate has just one year of industry experience, data extraction service 106 can assign the candidate a low value, such as 2, for that criteria. A similar process is performed for other criteria within criteria 611, and a score 621 is determined for each candidate by summing the values generated for each criterion.

In Step 630, data extraction service 106 presents top M candidates to employer based on score 621 on employer computing device 311. Step 630 optionally can be performed using a web site provided by computing device 320 and accessed and displayed by employer computing device 311 (such as a mobile device) or using an API and software application running on employer computing device 311 (such as a mobile device). Step 630 also can be performed by sending an SMS or MMS message or email from computing device 320 to employer computing device 311.

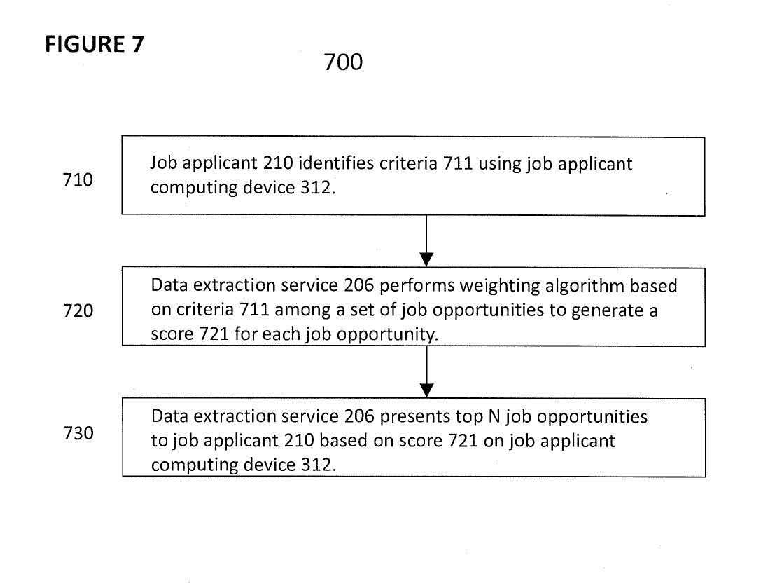

FIG. 7 depicts an alternative to FIG. 5. A method 700 of using recruitment system 100 to identify top job opportunities for job applicant is depicted. In Step 710, job applicant identifies criteria 711 using job applicant computing device 312. For example, job applicant might identify criteria 711 such as: salary of at least $50,000 (US); health insurance provided; job located in London, England.

In Step 720, data extraction service 206 performs a weighting algorithm based on criteria 711 among a set of job opportunities to generate a score for each job opportunity. The weighting used can be set by job applicant, or it can be set by recruitment system 100.

A simple example of Step 720 is the following. Criteria 711 comprises a criteria of salary of $50,000 (US). If a job opportunity has a salary of $50,000 (US) or greater, data extraction service 106 can assign that candidate a value of 20 for that criteria. If a job opportunity has a salary of $40,000 (US), data extraction service 106 can assign the job opportunity a value of 16 for that criteria. If the job opportunity has a salary of $20,000 (US), data extraction service 106 can assign the job opportunity a low value, such as 2, for that criteria. A similar process is performed for other criteria within criteria 711, and a score 721 is determined for each candidate by summing the values generated for each criterion.

In Step 730, data extraction service 206 presents top N job opportunities to job applicant based on score 721 on job applicant computing device 312. Step 730 optionally can be performed using a web site provided by computing device 320 and accessed and displayed by job applicant computing device 312 (such as a mobile device) or using an API and software application running on employer computing device 312 (such as a mobile device). Step 730 also can be performed by sending an SMS or MMS message or email from computing device 320 to job applicant computing device 312.

With reference again to FIG. 4, if optimal criteria 412 comprises more than one criteria, a score 621 can be generated using the weighting algorithm of step 620 (in FIG. 6), and in step 440, the top M candidates can be presented based on score.

With reference again to FIG. 5, if optimal criteria 512 comprises more than one criteria, a score 721 can be generated using the weighting algorithm of step 720 (in FIG. 7), and in step 540, the top N job opportunities can be presented based on score.

The above described methods can be performed using a web server, employer computing device 311, and job applicant computing device 312.

Using the methods described above, recruitment system 100 can provide a “short list” of top M candidates to employer that are optimized for the job opening, and recruitment system 100 also can provide a “short list” of top N job opportunities to job applicant that are optimized for job applicant. This is particularly desirable when a candidate or employer is utilizing the embodiments from a mobile device such as a smartphone.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between).

What is claimed is:

1. A method of identifying top candidates for an employer, comprising:
identifying, by a first computing device, essential criteria and optimal criteria for a job opportunity;
identifying, by a data extraction service running on a second computing device, a set of candidates who satisfy the essential criteria and generating a first dataset;
ranking, by the data extraction service, candidates within the first dataset based on optimal criteria;
transmitting, by the second computing device to the first computing device, a list of the top M candidates from the ranking step, where M is an integer;
displaying, by the first computing device, the top M candidates.

2. The method of claim 1, wherein the essential criteria comprise one or more of the following: college degree, years of experience, and job location.

3. The method of claim 2, wherein the optimal criteria comprise years of experience.

4. The method of claim 1, wherein the optimal criteria comprise a plurality of criteria.

5. The method of claim 5, wherein the ranking step comprises performing a weighting algorithm using the optimal criteria to generate a score for each candidate in the first dataset.

6. The method of claim 1, wherein M is predetermined by a user.

7. The method of claim 1, wherein the first computing device is a mobile device.

8. The method of claim 1, wherein the transmitting comprises providing a web page.

9. The method of claim 1, wherein the transmitting comprises sending an MMS or SMS message.

10. The method of claim 1, further comprising authenticating the employer by an authentication service running on the second computing device.

11. A method of identifying top job opportunities for a candidate, comprising:
identifying, by a first computing device, essential criteria and optimal criteria for a job opportunity;
identifying, by a data extraction service running on a second computing device, a set of job opportunities that satisfy the essential criteria to generate a first dataset;
ranking, by the data extraction service, job opportunities within the first dataset based on the optimal criteria; and
transmitting, by the second computing device to the first computing device, a list of the top N job opportunities from the ranking step, where N is an integer;
displaying, by the first computing device, the top N job opportunities.

12. The method of claim 11, wherein the essential criteria comprise one or more of the following: salary, health insurance, and job location.

13. The method of claim 12, wherein the optimal criteria comprises: salary.

14. The method of claim 11, wherein the optimal criteria comprises a plurality of criteria.

15. The method of claim 15, wherein the ranking step comprises performing a weighting algorithm using the optimal criteria to generate a score for each job opportunity in the first dataset.

16. The method of claim 11, wherein N is predetermined by the candidate.

17. The method of claim 11, wherein the computing device is a mobile device.

18. The method of claim 11, wherein the transmitting comprises providing a web page.

19. The method of claim 11, wherein the transmitting comprises sending an MMS or SMS message.

20. The method of claim 11, further comprising authenticating the candidate by an authentication service running on the second computing device.
